(19) United States
(12) Patent Application Publication
(10) Pub. No.: US 2015/0356042 A1
(43) Pub. Date: Dec. 10, 2015

(54) COMPUTER SYSTEM, SWITCHING DEVICE, AND SWITCHING METHOD

(71) Applicant: FUJITSU LIMITED, Kawasaki-shi (JP)

(72) Inventors: Shingo Ochiai, Kawasaki (JP); Haruhiko Sakai, Machida (JP)

(73) Assignee: FUJITSU LIMITED, Kawasaki (JP)

(21) Appl. No.: 14/685,877

(22) Filed: Apr. 14, 2015

(30) Foreign Application Priority Data
Jun. 6, 2014 (JP) 2014-117775

(51) Int. Cl. G06F 13/40

(52) U.S. Cl. CPC G06F 13/4022

(57) ABSTRACT

A computer system including a peripheral device including at least one of an input device and an output device; a plurality of computers; and a switching device that includes a plurality of connectors and a memory, the plurality of connectors including a connector group to which the plurality of computers are coupled and an input-output connector to which the peripheral device is coupled, the switching device coupling one connector of the connector group and the input-output connector, wherein the switching device is configured to: receive identification data for identifying a computer; and connect the input-output connector and a first connector of the connector group, the first connector being represented by a first connector identifier having been associated with the received identification data and stored in the memory, when the received identification data has been stored in the memory.

### CROSS-REFERENCE TO RELATED APPLICATION

This application is based upon and claims the benefit of priority of the prior Japanese Patent Application No. 2014-117775, filed on Jun. 6, 2014, the entire contents of which are incorporated herein by reference.

### FIELD

The embodiment discussed herein is related to a computer system, a switching device, and a switching method.

### BACKGROUND

A KVM switch is a device used when a plurality of servers are monitored or operated by using a set of a display, a keyboard, and a mouse. Here, a server is a computer that provides an information processing service. As for KVM, K stands for keyboard, V stands for visual unit, and M stands for mouse.

FIG. 15 illustrates a KVM switch. As illustrated in FIG. 15, four servers 8 denoted as a server #1 to a server #4, a display 3, a keyboard 4, and a mouse 5 are coupled to a KVM switch 9. Each server 8 and the KVM switch 9 are coupled to each other with a KVM signal cable. The display 3, the keyboard 4, and the mouse 5 are similarly coupled to the KVM switch 9 with a KVM signal cable.

The KVM switch 9 includes four server-switching switches 91 associated with the respective server #1 to server #4. When a server-switching switch 91 corresponding to a server #i (i=a number from 1 to 4) is operated, the display 3, the keyboard 4, and the mouse 5 are coupled to the server #i. Here, for convenience of explanation, there is provided the case where the four servers 8 are switched by the KVM switch 9. However, the KVM switch 9 is capable of switching between more servers 8.

There has been disclosed an input-output switching device in which a plurality of information processing apparatuses are selectively switched in accordance with a control signal input or output from an information processing apparatus, display information of a selected information processing apparatus is displayed on a display apparatus, and the selected information processing apparatus is controlled by using a keyboard, a mouse, or the like.

There has been disclosed a monitor switch in which a signal output from a computer after power is applied is detected by a central processing unit (CPU), and lines are automatically switched so that the computer having output the signal is coupled to a monitor. Examples of the related art include Japanese Laid-open Patent Publication No. 2005-4297 and Japanese Laid-open Patent Publication No. 2001-215942.

The KVM switch 9 illustrated in FIG. 15 has a problem in that it is difficult to switch to a server 8 desired to be coupled from among a lot of servers 8 by using a server-switching switch 91 with certainty. A known method of checking whether or not switching to the server 8 desired to be coupled has been done is a method of checking output screens of the respective servers 8. However, in the case where no information for distinguishing among the servers 8 is displayed, it is difficult to easily distinguish among the servers 8 by screen display. In the case where the same operating system (OS) is running in a plurality of servers 8, the respective screens of them are remarkably similar to one another, and thus it is difficult to easily distinguish among the servers 8 by screen display.

To specify a correspondence between a target server 8 and a server-switching switch 91 with certainty, it is desirable to check a connection while pulling on a cable between the KVM switch 9 and the server 8 by hand. However, when the servers 8 and the KVM switch 9 are mounted in a rack, connection cables are placed on a rack back side, and thus so many cables are typically placed on the rack back side. In this case, an operator of a computer system goes around to the rack back side, finds a specific cable from among a large number of cables, and pulls on the cable to check a destination to which a connection is made. It is significantly difficult work to check a destination to which a connection is made.

In some cases, there is adopted, for example, a method in which labels or the like are put near the server-switching switches 91 of the KVM switch 9 so as to indicate the server-switching switches 91 and the names of the servers coupled to them, and thereby to facilitate switching operation. However, if connections between the KVM switch 9 and the servers 8 are unexpectedly changed after system maintenance, a combination of indicated information and a coupled server 8 is changed. In this case, switching to a target server 8 may not be able to be performed correctly by using a server-switching switch 91. It is preferable to switch to a computer desired to be coupled to a peripheral device from among a plurality of computers with certainty and ease.

### SUMMARY

According to an aspect of the invention, a computer system including a peripheral device including at least one of an input device and an output device; a plurality of computers; and a switching device that includes a plurality of connectors and a memory, the plurality of connectors including a connector group to which the plurality of computers are coupled and an input-output connector to which the peripheral device is coupled, the switching device coupling one connector of the connector group and the input-output connector, wherein the switching device is configured to: receive identification data for identifying a computer; and connect the input-output connector and a first connector of the connector group, the first connector being represented by a first connector identifier having been associated with the received identification data and stored in the memory, when the received identification data has been stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a computer system according to an embodiment;

FIG. 2 illustrates an example of a Key image;

FIG. 3 illustrates an example of a composite image;

FIG. 4 illustrates an example of a correspondence table;

FIGS. 5A and 5B illustrate an example of updating of the correspondence table in the case where a Key image does not exist in the correspondence table;

FIGS. 6A and 6B illustrate an example of updating of the correspondence table in the case where a connector number of a connector pair having received a Key image differs from a connector number corresponding to the Key image in the correspondence table;

FIGS. 7A and 7B illustrate an example of updating of the correspondence table in the case where a connector number has not been stored in the correspondence table;

FIG. 8 illustrates a configuration of a KVM switch in the case where a keyboard and a mouse are coupled to a server with USB;

FIG. 9 is a flowchart illustrating a flow of a process performed by an image detection unit;

FIG. 10 is a flowchart illustrating a flow of Key image processing performed by a correspondence table control unit;

FIG. 11 is a flowchart illustrating a flow of a process performed by the correspondence table control unit when a server-switching switch is pressed;

FIG. 12 is a flowchart illustrating a flow of a process performed by a connection switching control unit;

FIG. 13 illustrates a hardware configuration of a server;

FIG. 14 is a flowchart illustrating a flow of a process performed by the server when a Key image transmission switch is pressed; and

FIG. 15 illustrates a KVM switch.

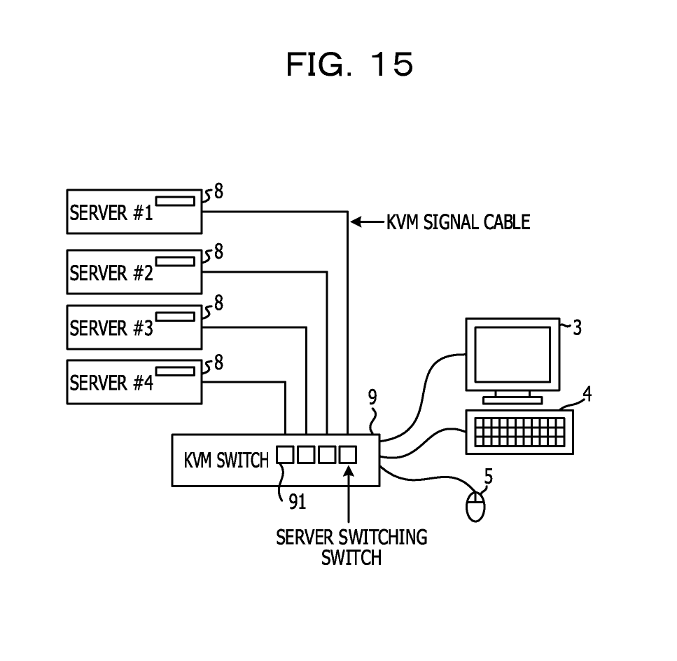

### DESCRIPTION OF EMBODIMENT

An embodiment of a switching device, a computer system, and a switching method that are disclosed in this application will be described in detail below with reference to the drawings. The embodiment does not limit a disclosed technique.

### Embodiment

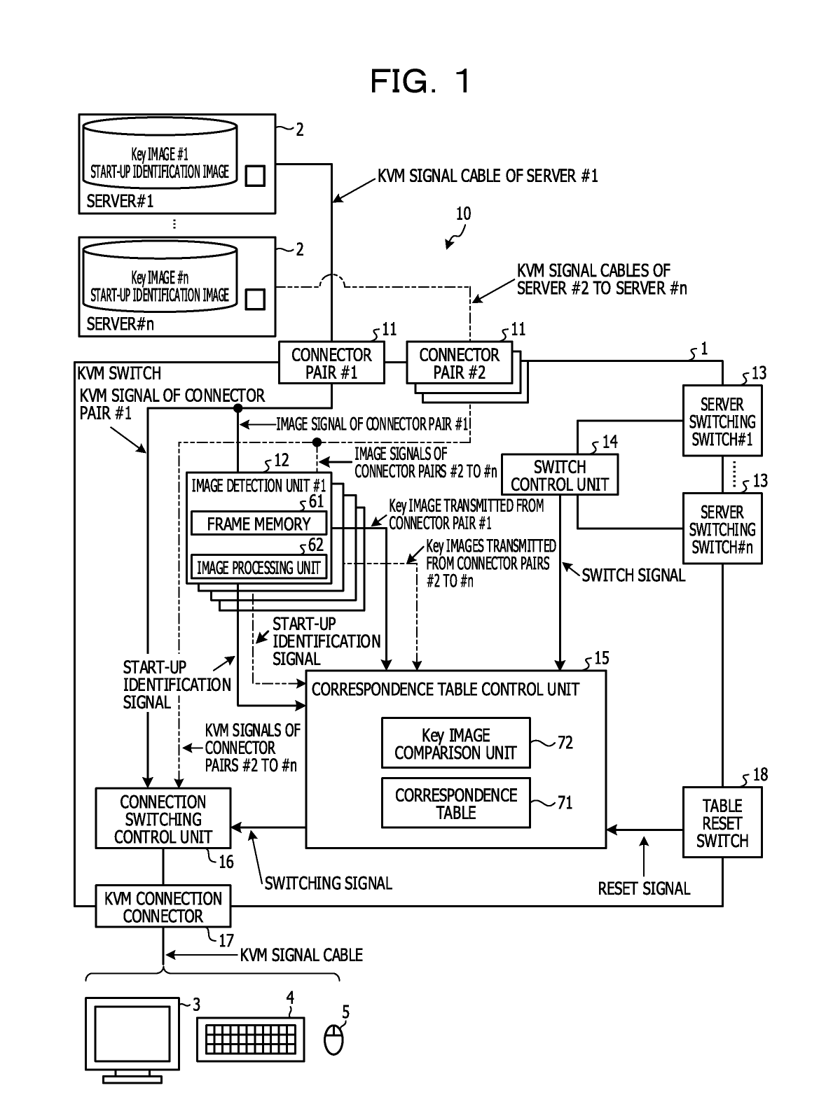

First, a configuration of a computer system according to the embodiment will be described. FIG. 1 illustrates the configuration of the computer system according to the embodiment. As illustrated in FIG. 1, a computer system 10 according to the embodiment includes a KVM switch 1, an n number of servers 2 denoted by a server #1 to a server #n, a display 3, a keyboard 4, and a mouse 5.

The display 3 is a device that displays display information of a server 2 coupled to the display 3 with the KVM switch 1 among the server #1 to the server #n. The keyboard 4 is a device for inputting data to the server 2 coupled to the keyboard 4 with the KVM switch 1 among the server #1 to the server #n. The mouse 5 is a device used for, for example, controlling information displayed on the display 3, or selecting from among items displayed on the display 3.

Each server 2 is a computer that provides an information processing service. Each server 2 is coupled to one of an n number of connector pairs 11 denoted by a connector pair #1 to a connector pair #n of the KVM switch 1 with a KVM signal cable. That is, the server #1 is coupled to the connector pair #1, the server #2 is coupled to the connector pair #2, . . . , and the server #n is coupled to the connector pair #n.

Each server 2 has a Key image transmission switch 27. When the Key image transmission switch 27 is pressed, the server 2 outputs a stored Key image 2a to the KVM switch 1. The Key image 2a is used for switching between the servers 2 to be coupled to the display 3, the keyboard 4, and the mouse 5 with the KVM switch 1.

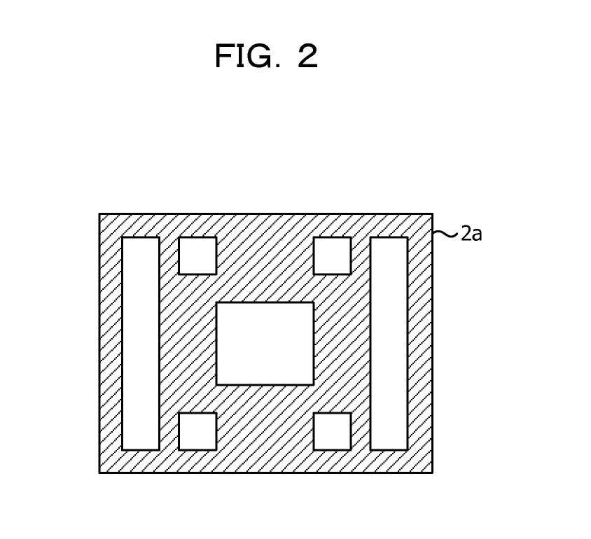

FIG. 2 illustrates an example of the Key image 2a. As illustrated in FIG. 2, the Key image 2a has a specific feature. It is noted that the Key image 2a has a pattern different between the servers 2. That is, a Key image #1 that the server #1 has, a Key image #2 that the server #2 has, . . . , and a Key image #n that the server #n has are different from one another in terms of a pattern.

Each server 2 stores a start-up identification image 2b, and outputs, for a certain time period upon start-up, a composite image obtained by combining the start-up identification image 2b and the Key image 2a to the KVM switch 1. The start-up identification image 2b is an image common to the server #1 to the server #n.

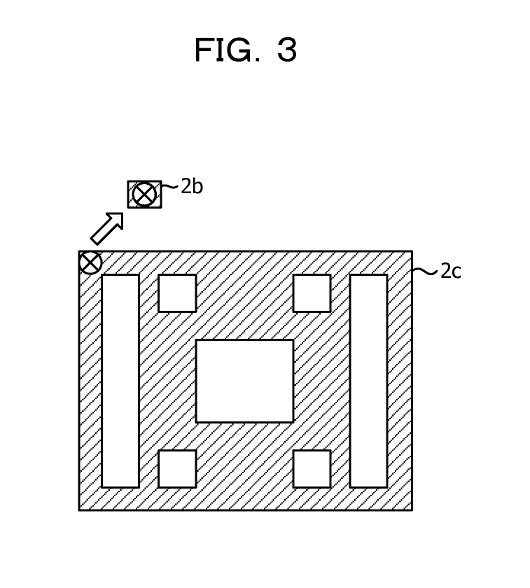

FIG. 3 illustrates an example of the composite image. As illustrated in FIG. 3, a composite image 2c contains the Key image 2a and the start-up identification image 2b such that they are able to be individually identified. The composite image 2c is used by the KVM switch 1 for registration and modification of the Key image 2a.

The KVM switch 1 is a device that switches between the servers 2 to be coupled to the display 3, the keyboard 4, and the mouse 5. The KVM switch 1 includes the n number of connector pairs 11, an n number of image detection units 12 denoted by an image detection unit #1 to an image detection unit #n, an n number of server-switching switches 13 denoted by a server-switching switch #1 to a server-switching switch #n, and a switch control unit 14. The KVM switch 1 includes a correspondence table control unit 15, a connection switching control unit 16, a KVM connection connector 17, and a table reset switch 18.

The connector pairs 11 are connection units for connecting to the servers 2 with KVM signal cables. The connector pairs 11 include a connector for a display signal cable, a connector for a keyboard signal cable, and a connector for a mouse signal cable. Connectors for display signal cables of the connector pair #1 to the connector pair #n are coupled to the respective image detection unit #1 to image detection unit #n. The connector pair #1 to the connector pair #n are coupled to the connection switching control unit 16.

Each image detection unit 12 detects a Key image 2a and a start-up identification image 2b that are contained in an image signal transmitted from a corresponding connector pair 11. Then, the image detection unit 12 outputs the detected Key image 2a and a start-up identification signal to the correspondence table control unit 15. Here, the start-up identification signal is a signal representing whether or not the start-up identification image 2b has been detected. When the start-up identification image 2b has been detected, the start-up identification signal is ON, and when the start-up identification image 2b has not been detected, the start-up identification signal is OFF.

Each image detection unit 12 includes a frame memory 61 and an image processing unit 62. The frame memory 61 is a memory that stores an image transmitted from a server 2. The image processing unit 62 detects the Key image 2a and the start-up identification image 2b from the image stored in the frame memory 61.

The server-switching switches 13 are switches used for switching between the servers 2 to be coupled to the display 3, the keyboard 4, and the mouse 5. When the server-switching switch #1 is pressed, the server #1 is coupled to the display 3, the keyboard 4, and the mouse 5. When the server-switching switch #2 is pressed, the server #2 is coupled to the display 3, the keyboard 4, and the mouse 5. Similarly, when the server-switching switch #n is pressed, the server #n is coupled to the display 3, the keyboard 4, and the mouse 5. When each server-switching switch 13 is pressed, the server-switching switch 13 outputs identification information thereof to the switch control unit 14.

The switch control unit 14 outputs, as a switch signal, identification information of a pressed server-switching switch 13 to the correspondence table control unit 15.

The correspondence table control unit 15 receives the switch signal from the switch control unit 14. Subsequently, the correspondence table control unit 15 outputs, as a switching signal, a signal representing a connector number corresponding to the pressed server-switching switch 13 to the connection switching control unit 16. Here, the connector number is a number for identifying a connector pair 11, and is an integer from 1 to n.

The correspondence table control unit 15 outputs, as a switching signal, a signal representing a connector number corresponding to a server 2 to be coupled to the display 3, the keyboard 4, and the mouse 5 to the connection switching control unit 16 by using a Key image 2a and a start-up identification signal output by an image detection unit 12.

The correspondence table control unit 15 includes a correspondence table 71 and a Key image comparison unit 72. The correspondence table 71 associates switch numbers for identifying the server-switching switches 13 with respective connector numbers, and with respective Key images 2a transmitted from the connector pairs 11 identified by the respective connector numbers, and stores them for each switch number.

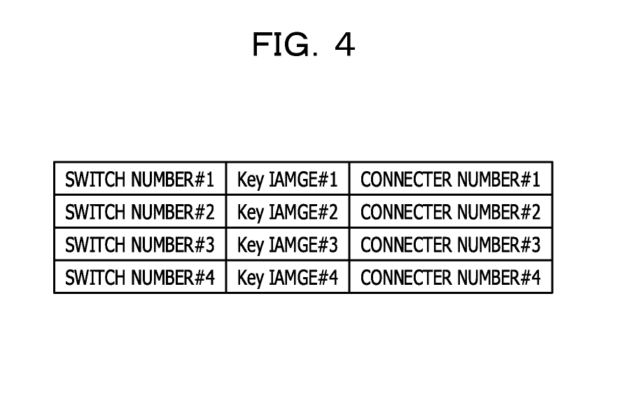

FIG. 4 illustrates an example of the correspondence table 71. In FIG. 4, a switch number #i, a Key image #i, and a connector number #i are associated with one another, where i=an integer from 1 to 4, and they are stored. In this case, when a server-switching switch #i is pressed, the correspondence table control unit 15 instructs the connection switching control unit 16 to connect a connector pair #i to the display 3, the keyboard 4, and the mouse 5. When the correspondence table 71 is in an initial state, a switch number and a connector number is set as follows: switch number #1 to connector number #1, switch number #2 to connector number #2, . . . , and switch number #n to connector number #n. In the initial state, no Key image is stored in the correspondence table 71.

The Key image comparison unit 72 compares a Key image 2a output by an image detection unit 12 with each Key image 2a stored in the correspondence table 71. The correspondence table control unit 15 controls output of a connector number and updating of the correspondence table 71 by using a comparison result provided by the Key image comparison unit 72 and a start-up identification signal output by the image detection unit 12.

In accordance with a switching signal output by the correspondence table control unit 15, the connection switching control unit 16 switches between a connection of the display 3, the keyboard 4, and the mouse 5 to a server 2, and a connection of them to another server 2. Specifically, the connection switching control unit 16 connects the KVM connection connector 17 to one of the n number of connector pairs 11 in accordance with a switching signal output by the correspondence table control unit 15.

The KVM connection connector 17 is a connector for connecting the display 3, the keyboard 4, and the mouse 5 to the KVM switch 1. When the table reset switch 18 is pressed by an operator, the table reset switch 18 instructs the correspondence table control unit 15 to reset the correspondence table 71, and also resets the server-switching switches 13. When the correspondence table control unit 15 is instructed to reset the correspondence table 71, the correspondence table control unit 15 initializes connector numbers and erases Key images 2a in the correspondence table 71. Switch numbers are fixedly stored.

Next, there will be described processes performed by the correspondence table control unit 15, that is, a process performed when the KVM switch 1 receives a start-up identification image 2b together with a Key image 2a, and a process performed when the KVM switch 1 receives only a Key image 2a.

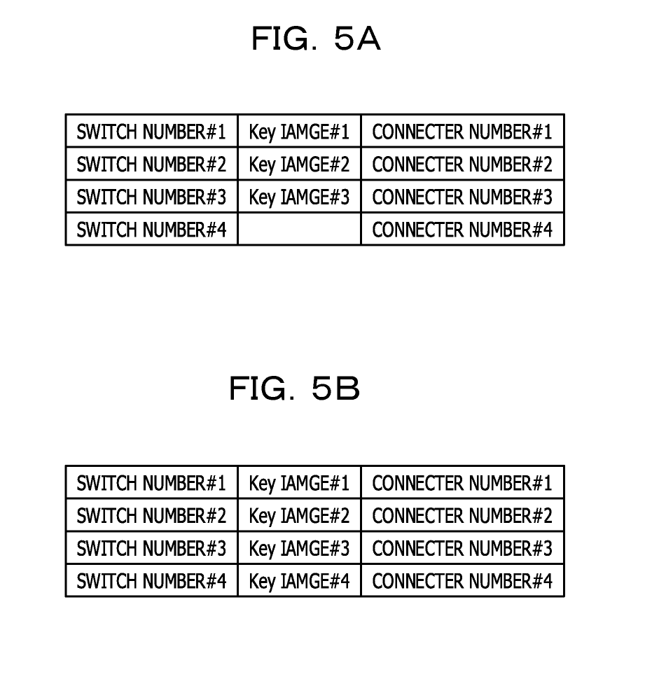

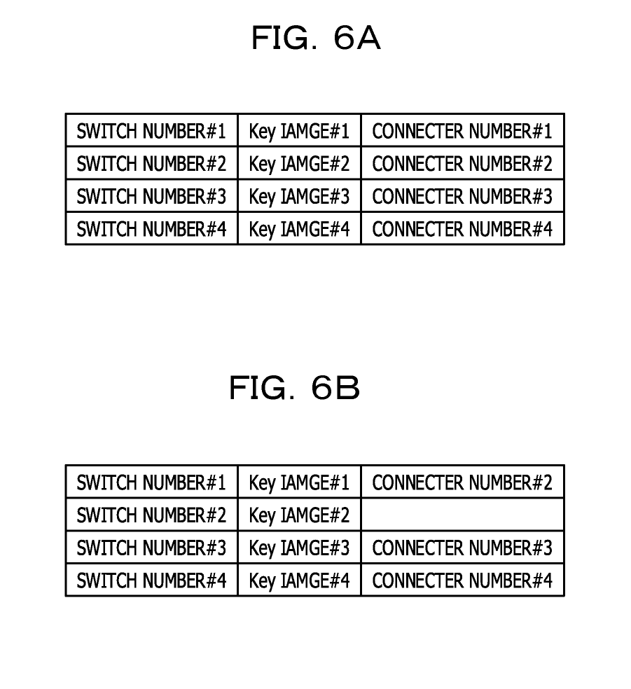

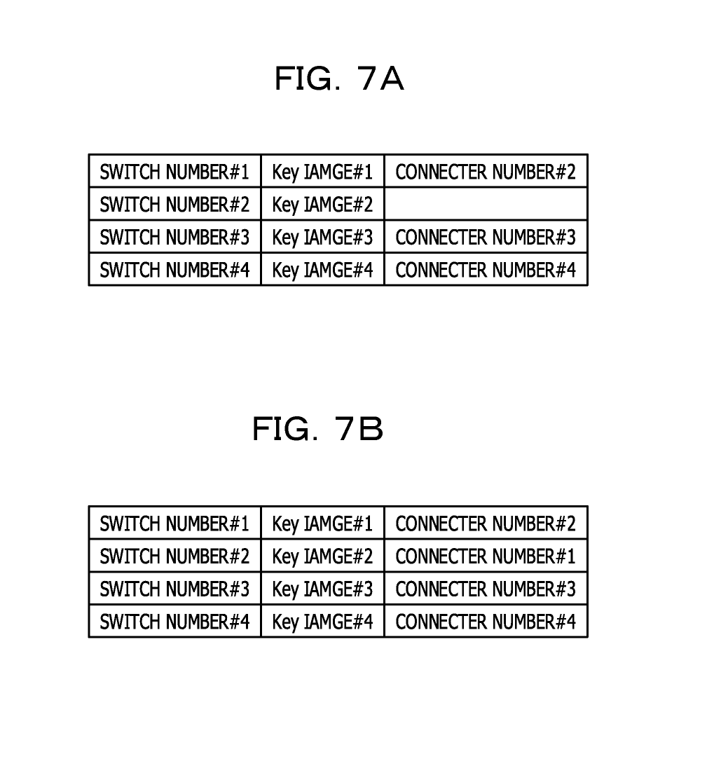

FIGS. 5A, 5B, 6A, 6B, 7A, and 7B illustrate an example of updating of the correspondence table 71 in the case where the KVM switch 1 receives a start-up identification image 2b together with a Key image 2a. FIGS. 5A and 5B illustrate an example of updating of the correspondence table 71 in the case where a Key image 2a does not exist in the correspondence table 71. FIGS. 6A and 6B illustrate an example of updating of the correspondence table 71 in the case where a connector number of a connector pair 11 having received a Key image 2a differs from a connector number corresponding to the Key image 2a in the correspondence table 71. FIGS. 7A and 7B illustrate an example of updating of the correspondence table 71 in the case where a connector number has not been stored in the correspondence table 71.

When a Key image 2a transmitted by an image detection unit #i does not exist in the correspondence table 71, the correspondence table control unit 15 writes, as a Key image #i corresponding to a connector number #i of a connector pair #i having received the Key image 2a, the transmitted Key image 2a into the correspondence table 71.

For example, when a server 2 is coupled to the KVM switch 1 and started up first, a Key image 2a stored in the server 2 has not been stored in the correspondence table 71. FIGS. 5A and 5B illustrate states of the correspondence table 71 before and after detection in the case where the server #4 is coupled to the connector pair #4 and the Key image #4 is detected in a state in which the server #1 to the server #3 have already been coupled to the KVM switch 1 and the Key image #1 to the Key image #3 have been registered in the correspondence table 71. As illustrated in FIG. 5A, before the Key image #4 is detected, the Key image #4 has not been stored in the correspondence table 71. On the other hand, as illustrated in FIG. 5B, when the Key image #4 is detected and the correspondence table 71 is rewritten, the Key image #4 is associated with the connector number #4 and stored in the correspondence table 71.

This case is the case where the server #4 has been started up, and the correspondence table control unit 15 does not therefore perform a server connection switching operation. FIG. 5B illustrates a state in which the correspondence table 71 has been initialized automatically after the computer system 10 in which n =4 is provided was constructed.

When the Key image 2a transmitted by the image detection unit #i has been associated with the connector number #i and registered in the correspondence table 71, the correspondence table control unit 15 does not update the correspondence table 71. For example, after the correspondence table 71 is initialized, when the computer system 10 is started up for normal operation, the Key image 2a transmitted by the image detection unit #i has been associated with the connector number #i and registered in the correspondence table 71, and thus the correspondence table 71 is not updated. This case is the case where a server 2 has been started up, and the correspondence table control unit 15 does not therefore perform a server connection switching operation.

The Key image 2a transmitted by the image detection unit #i exists in the correspondence table 71. However, when the Key image 2a has been associated with a connector number #j different from the connector number #i and registered in the correspondence table 71, the correspondence table control unit 15 updates the correspondence table 71. Specifically, the correspondence table control unit 15 erases the connector number #i from the correspondence table 71, and changes the connector number #j to the connector number #i. For example, such a situation occurs when the operator or a maintenance person unintentionally starts up a server 2 in a state in which a connection between a server #i and the connector pair #i is different from that in the correspondence table 71.

FIGS. 6A and 6B illustrate the case where the server #1 is coupled to the connector pair #1, the server #2 is coupled to the connector pair #2, the KVM switch 1 is then initialized, subsequently the server #1 is coupled to the connector pair #2, the server #2 is coupled to the connector pair #1, and the server #1 is then started up. At this time, the Key image #1 is output from the connector pair #2. Although the Key image #1 exists in the correspondence table 71, a connector number corresponding to the Key image #1 is the connector number #1. In this case, as illustrated in FIG. 6B, the correspondence table control unit 15 erases the connector number #2 contained in the correspondence table 71, and changes the connector number #1 to the connector number #2. This case is the case where the server #1 has been started up, and the correspondence table control unit 15 does not therefore perform a server connection switching operation.

In a state illustrated in FIG. 6B, there is not a connector corresponding to the server-switching switch #2, and thus switching is not performed even if the server-switching switch #2 is pressed. However, because the server #2 corresponding to the Key image #2 is not operating, there is no problem even if switching is not performed, and also a connection to another server is not erroneously made.

Subsequently, when the server #2 is started up, the Key image #2 is output from the connector pair #1. Although the Key image #2 exists in the correspondence table 71, there is not a corresponding connector number. At this time, the correspondence table control unit 15 stores, as a connector number corresponding to the Key image #2, the connector number #1. FIGS. 7A and 7B illustrate an example of updating of the correspondence table 71 in the case where a connector number has not been stored. As illustrated in FIG. 7B, the connector number #1 is stored, as a connector number corresponding to the Key image #2, in the correspondence table 71.

This case is the case where the server #2 has been started up, and the correspondence table control unit 15 does not therefore perform a server connection switching operation. Thus, although a process performed by the correspondence table control unit 15 upon start-up of the server #2 is a process similar to that upon start-up of the server #1, erasing of the connector number #1 is omitted because the connector number #1 does not exist in the correspondence table 71.

Through such updating of the correspondence table 71, as illustrated in FIG. 7B, the connector pair #2 is associated with the server-switching switch #1, and the connector pair #1 is associated with the server-switching switch #2. Hence, when the server #1 is selected by using the server-switching switch #1, the display 3, the keyboard 4, and the mouse 5 are correctly coupled to the server #1. That is, even if connections between the KVM switch 1 and the servers 2 are unexpectedly changed, the correspondence table 71 is automatically modified, thereby making it possible to correctly connect the display 3, the keyboard 4, and the mouse 5 to a server 2 to be operated by using a server-switching switch 13.

Next, there will be described a process performed by the correspondence table control unit 15 when the operator presses the Key image transmission switch 27 of a server 2 and the KVM switch 1 receives only a Key image 2a. When the received Key image 2a exists in the correspondence table 71 and the number of a connector pair 11 having received the Key image 2a coincides with a connector number contained in the correspondence table 71, the correspondence table control unit 15 does not update the correspondence table 71.

This case corresponds to the case where the operator presses a Key image transmission switch 27 on a server 2 side in normal operation (after initialization), and is the case where a combination of a Key image 2a and a connector number has already been stored in the correspondence table 71 at the time of initialization. Because there is no start-up identification image 2b, and because switching between a connection of the display 3, the keyboard 4, and the mouse 5 to a server 2, and a connection of them to another server 2 is to be performed, the correspondence table control unit 15 outputs the connector number as a switching signal.

When a received Key image 2a exists in the correspondence table 71 and a connector number of a connector pair 11 having received the Key image 2a does not coincide with a connector number corresponding to the Key image 2a contained in the correspondence table 71, the correspondence table control unit 15 rewrites the correspondence table 71. A rewriting process performed by the correspondence table control unit 15 in this case is similar to the rewriting processes illustrated in FIGS. 6A, 6B, 7A, and 7B.

This case corresponds to an abnormal case where the operator has changed connections between the connector pairs 11 and the servers 2 due to maintenance or the like unexpectedly and without turning the power of the device off (the operator normally turns the power off when connections are changed). Because there is no start-up identification image 2b, and because switching between a connection of the display 3, the keyboard 4, and the mouse 5 to a server 2, and a connection of them to another server 2 is to be performed, the correspondence table control unit 15 outputs a connector number as a switching signal.

In the case where a received Key image 2a does not exist in the correspondence table 71, the correspondence table control unit 15 rewrites the correspondence table 71 as in the case illustrated in FIGS. 5A and 5B. This case corresponds to an abnormal case where the operator has coupled a server 2 to a connector pair 11 which has not been used at the time of initialization unexpectedly and without turning the power of the device off (the operator normally turns the power off when connections are changed). Because there is no start-up identification image 2b, and because switching between a connection of the display 3, the keyboard 4, and the mouse 5 to a server 2, and a connection of them to another server 2 is to be performed, the correspondence table control unit 15 outputs a connector number as a switching signal.

In this way, the correspondence table control unit 15 updates the correspondence table 71 in accordance with a received Key image 2a and the number of a connector pair 11, thereby making it possible to maintain correct connection states (correspondences between the servers 2 and the server-switching switches 13) on the correspondence table 71 at all times.

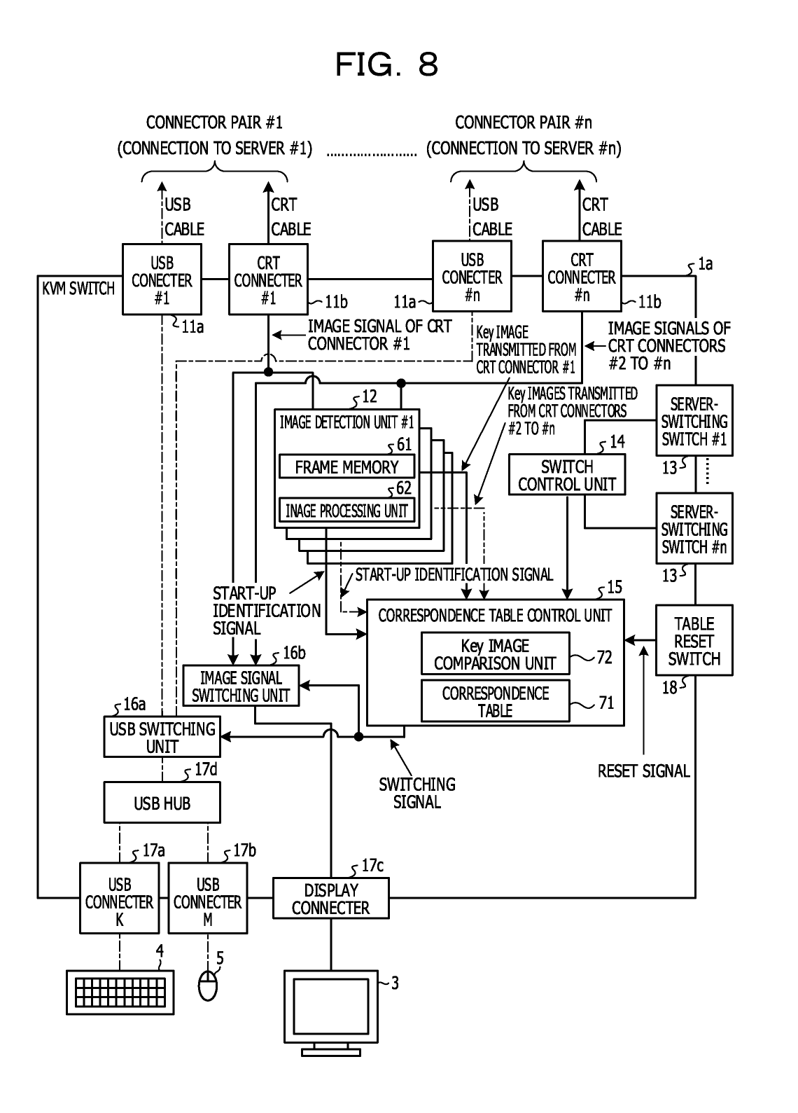

Next, a configuration of a KVM switch in the case where the keyboard 4 and the mouse 5 are coupled to a server with Universal Serial Bus (USB) will be described. FIG. 8 illustrates a configuration of a KVM switch is in the case where the keyboard 4 and the mouse 5 are coupled to a server with USB.

In comparison with the KVM switch 1 illustrated in FIG. 1, the KVM switch is includes, as a connector pair 11, a USB connector 11a and a cathode ray tube (CRT) connector 11b. The USB connector 11a is a connector for connecting to a server 2 with a USB cable. The CRT connector 11b is a connector for connecting to the server 2 with a CRT cable.

In addition, in comparison with the KVM switch 1 illustrated in FIG. 1, the KVM switch 1a includes, as the connection switching control unit 16, a USB switching unit 16a and an image signal switching unit 16b. The KVM switch 1a includes, as the KVM connection connector 17, a USB connector K 17a, a USB connector M 17b, a display connector 17c, and a USB HUB 17d.

In accordance with a switching signal output by the correspondence table control unit 15, the USB switching unit 16a switches between a connection of the keyboard 4 and the mouse 5 to a server 2 and a connection of them to another server 2. Specifically, the USB switching unit 16a connects the USB connector K 17a and the USB connector M 17b to one of an n number of USB connectors 11a in accordance with a switching signal output by the correspondence table control unit 15.

In accordance with a switching signal output by the correspondence table control unit 15, the image signal switching unit 16b switches between a connection of the display 3 to a server 2 and a connection of it to another server 2. Specifically, the image signal switching unit 16b connects the display connector 17c to one of an n number of CRT connectors 11b in accordance with a switching signal output by the correspondence table control unit 15.

The USB connector K 17a is a connector for connecting to the keyboard 4 with a USB cable. The USB connector M 17b is a connector for connecting to the mouse 5 with a USB cable. The display connector 17c is a connector for connecting to the display 3 with a CRT cable. The USB HUB 17d is a hub for connecting the USB switching unit 16a, and the USB connector K 17a and the USB connector M 17b.

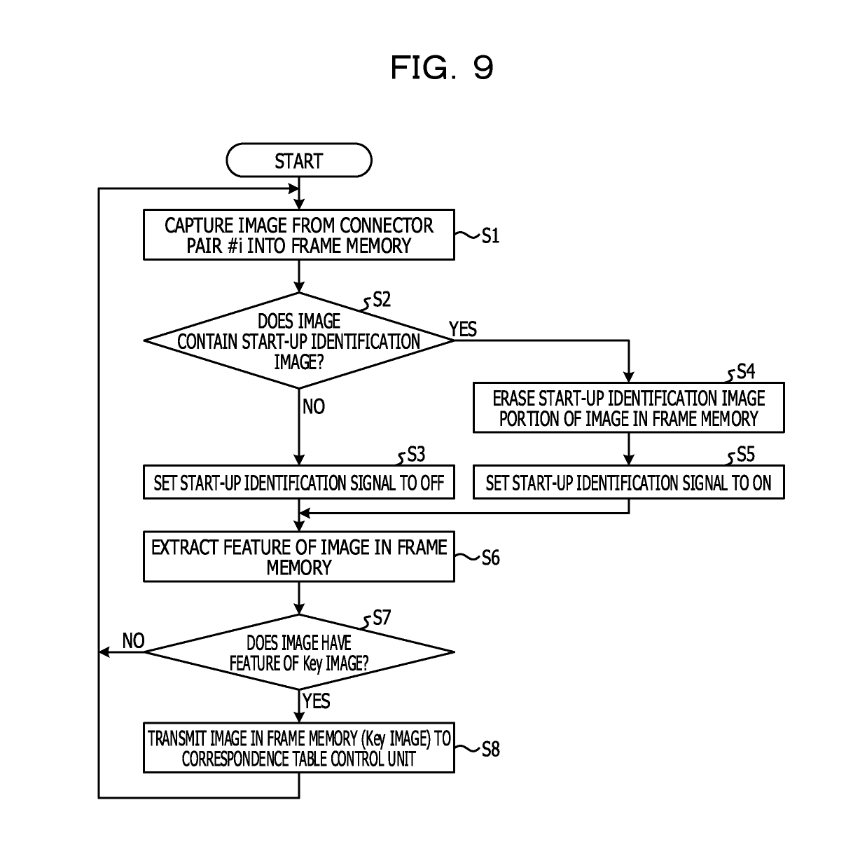

Next, a flow of a process performed by each image detection unit 12 will be described. FIG. 9 is a flowchart illustrating a flow of the process performed by the image detection unit 12. Here, a process performed when an image is transmitted to the image detection unit #i will be described.

As illustrated in FIG. 9, the image detection unit #i captures an image from the connector pair #i into the frame memory 61 (S1). Subsequently, the image detection unit #i determines whether or not the image contains a start-up identification image 2b (S2). When it is determined that the image does not contain a start-up identification image 2b (S2: No), the image detection unit #i sets a start-up identification signal to OFF (S3). On the other hand, when it is determined that the image contains a start-up identification image 2b (S2: Yes), the image detection unit #i erases a start-up identification image portion of the image in the frame memory 61 (S4), and sets a start-up identification signal to ON (S5).

Then, the image detection unit #i extracts a feature of the image in the frame memory 61 (S6). Subsequently, the image detection unit #i determines whether or not the image in the frame memory 61 is an image having a feature of a Key image 2a (S7). When it is determined that the image in the frame memory 61 is not an image having a feature of a Key image 2a (S7: No), the image detection unit #i returns to S1. On the other hand, when it is determined that the image in the frame memory 61 is an image having a feature of a Key image 2a (S7: Yes), the image detection unit #i transmits the image in the frame memory 61, that is, a Key image 2a to the correspondence table control unit 15 (S8).

In this way, the image detection unit #i detects a Key image 2a and a start-up identification image 2b, thereby enabling the correspondence table control unit 15 to perform a process based on the Key image 2a and the start-up identification image 2b.

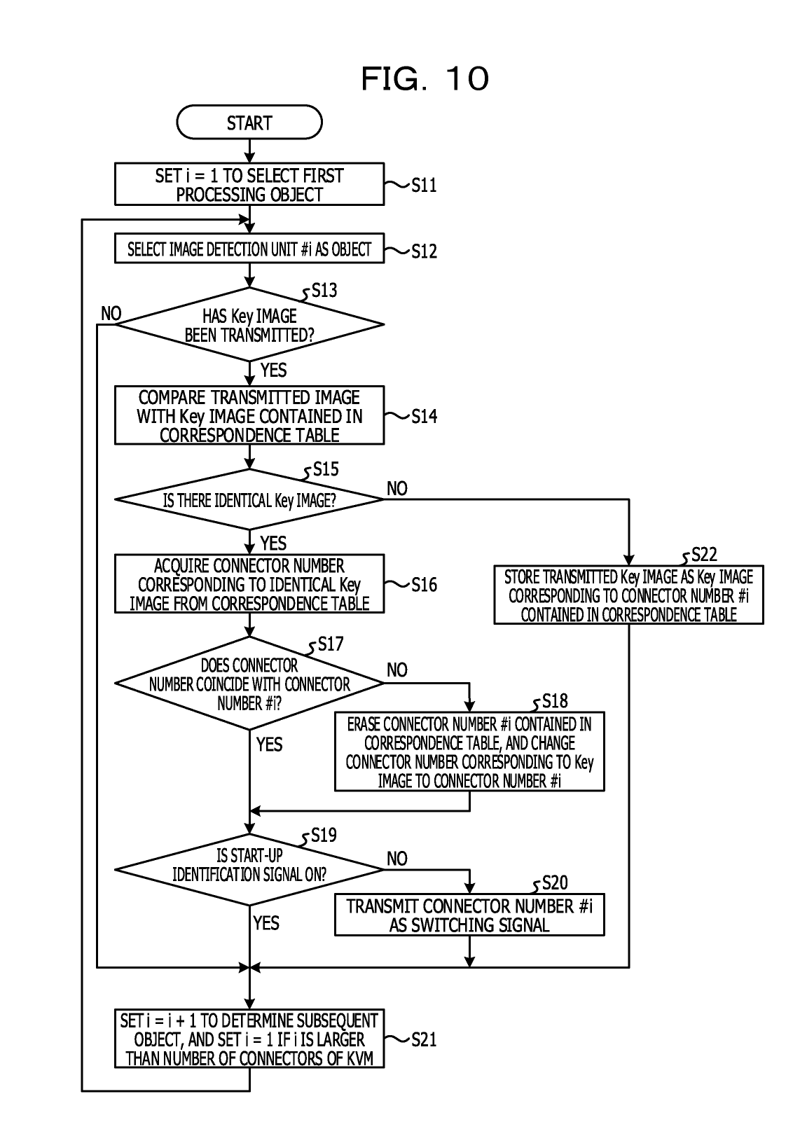

Next, a flow of Key image processing performed by the correspondence table control unit 15 will be described. FIG. 10 is a flowchart illustrating a flow of the Key image processing performed by the correspondence table control unit 15. First, the correspondence table control unit 15 sets i =1 to select a first processing object (S11).

Then, the correspondence table control unit 15 selects the image detection unit #i as a processing object (S12). Subsequently, the correspondence table control unit 15 determines whether or not a Key image 2a has been transmitted from the image detection unit #i (S13). When it is determined a Key image 2a has not been transmitted (S13: No), the correspondence table control unit 15 proceeds to S21.

On the other hand, when it is determined a Key image 2a has been transmitted (S13: Yes), the correspondence table control unit 15 compares the transmitted image with a Key image 2a contained in the correspondence table 71 (S14). Then, the correspondence table control unit 15 determines whether or not there is an identical Key image 2a in the correspondence table 71 (S15). When it is determined that there is no identical Key image 2a in the correspondence table 71 (S15: No), the correspondence table control unit 15 stores the transmitted Key image 2a as a Key image 2a corresponding to the connector number #i contained in the correspondence table 71 (S22).

On the other hand, when it is determined that there is an identical Key image 2a in the correspondence table 71 (S15: Yes), the correspondence table control unit 15 acquires a connector number corresponding to the identical Key image 2a from the correspondence table 71 (S16). Then, the correspondence table control unit 15 determines whether or not the acquired connector number coincides with the connector number #i (S17). When it is determined that the acquired connector number does not coincide with the connector number #i (S17: No), the correspondence table control unit 15 erases the connector number #i contained in the correspondence table 71, and changes the connector number corresponding to the Key image 2a to the connector number #i (S18). After the process of S18, the correspondence table control unit 15 proceeds to S19. On the other hand, when it is determined that the acquired connector number coincides with the connector number #i (S17: Yes), the correspondence table control unit 15 proceeds to S19.

The correspondence table control unit 15 determines whether or not a start-up identification signal is ON (S19). When it is determined that a start-up identification signal is ON (S19: Yes), the correspondence table control unit 15 proceeds to S21. On the other hand, when it is determined that a start-up identification signal is not ON (S19: No), the correspondence table control unit 15 transmits, as a switching signal, the connector number #i to the connection switching control unit 16 (S20). Then, the correspondence table control unit 15 proceeds to S21. Subsequently, the correspondence table control unit 15 sets i=i+1 to determine a subsequent object, and sets i=1 if i is larger than n (S21). Then, the correspondence table control unit 15 returns to S12.

In this way, the correspondence table control unit 15 outputs a switching signal in accordance with an image transmitted from an image detection unit 12, the correspondence table 71, and a start-up identification signal. Hence, the KVM switch 1 may switch between a connection of the display 3, the keyboard 4, and the mouse 5 to one of the n number of servers 2, and a connection of them to another one.

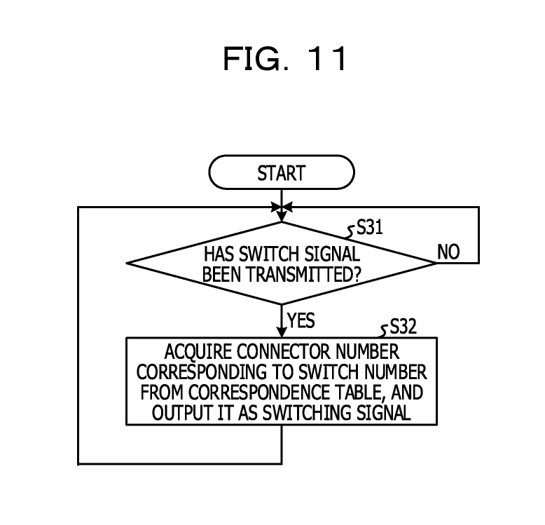

Next, a flow of a process performed by the correspondence table control unit 15 when a server-switching switch 13 is pressed will be described. FIG. 11 is a flowchart illustrating a flow of the process performed by the correspondence table control unit 15 when a server-switching switch 13 is pressed.

As illustrated in FIG. 11, the correspondence table control unit 15 determines whether or not a switch signal of a server-switching switch 13 has been transmitted (S31). When it is determined that no switch signal has been transmitted (S31: No), the correspondence table control unit 15 repeatedly performs the process of S31.

On the other hand, when it is determined that a switch signal of a server-switching switch 13 has been transmitted (S31: Yes), the correspondence table control unit 15 acquires a connector number corresponding to a switch number represented by the switch signal from the correspondence table 71, and outputs it as a switching signal (S32).

In this way, the correspondence table control unit 15 outputs a switching signal in accordance with a switch signal of a server-switching switch 13 and the correspondence table 71. Hence, the operator may switch between a connection of the display 3, the keyboard 4, and the mouse 5 to one of the n number of servers 2, and a connection of them to another one by using a server-switching switch 13.

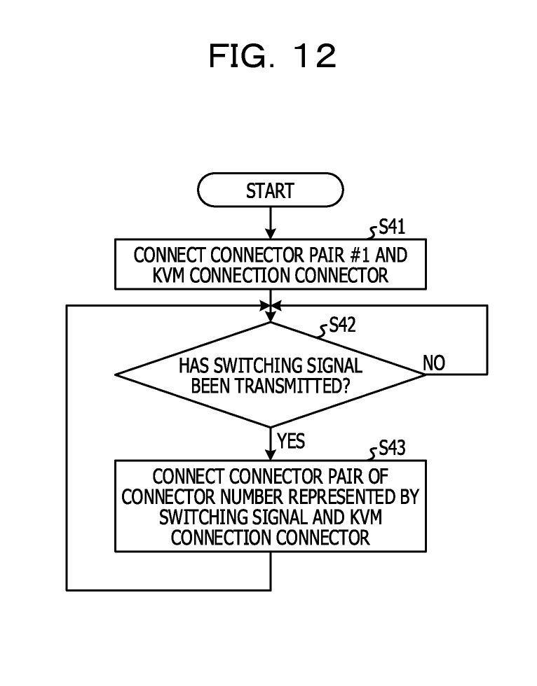

Next, a flow of a process performed by the connection switching control unit 16 will be described. FIG. 12 is a flowchart illustrating a flow of the process performed by the connection switching control unit 16. As illustrated in FIG. 12, the connection switching control unit 16 connects the connector pair #1 and the KVM connection connector 17 as initial setting (S41).

Then, the connection switching control unit 16 determines whether or not a switching signal has been transmitted from the correspondence table control unit 15 (S42). When it is determined that no switching signal has been transmitted from the correspondence table control unit 15 (S42: No), the connection switching control unit 16 repeatedly performs the process of S42.

On the other hand, when it is determined that a switching signal has been transmitted from the correspondence table control unit 15 (S42: Yes), the connection switching control unit 16 connects a connector pair 11 of a connector number represented by the switching signal and the KVM connection connector 17 (S43).

In this way, the connection switching control unit 16 switches between the connector pairs 11 to be coupled to the KVM connection connector 17 in accordance with a switching signal transmitted from the correspondence table control unit 15. Hence, the KVM switch 1 may switch between a connection of the display 3, the keyboard 4, and the mouse 5 to one of the n number of servers 2, and a connection of them to another one.

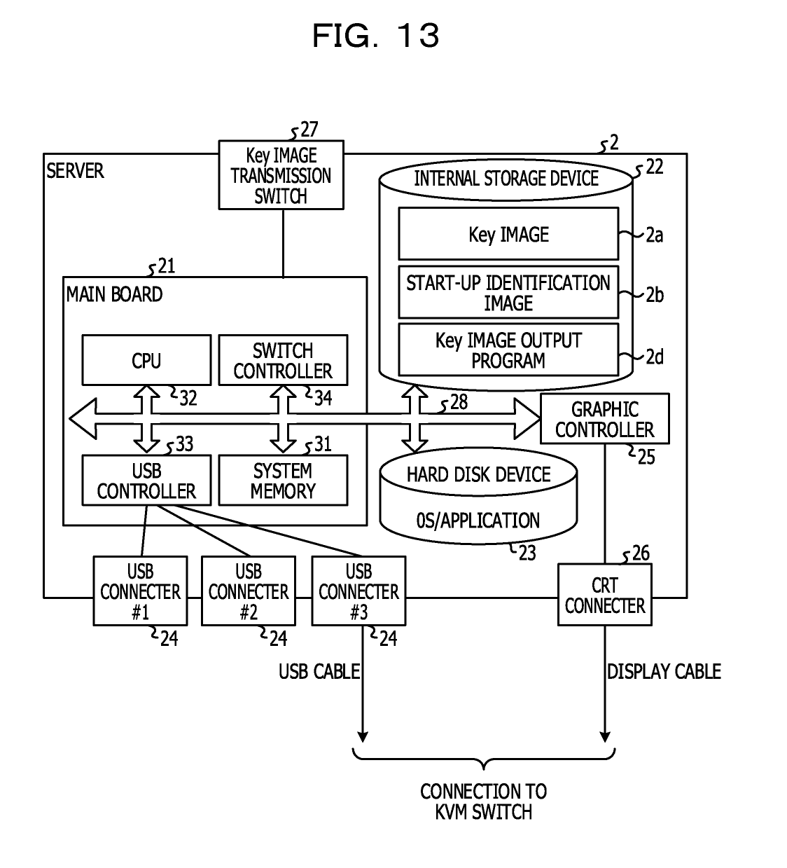

Next, a hardware configuration of each server 2 will be described. FIG. 13 illustrates a hardware configuration of the server 2. As illustrated in FIG. 13, the server 2 includes a main board 21, an internal storage device 22, a hard disk device 23, and three USB connectors 24 denoted by a USB connector #1 to a USB connector #3. The server 2 includes a graphics controller 25, a CRT connector 26, and the Key image transmission switch 27.

The main board 21 includes a system memory 31, a central processing unit (CPU) 32, a USB controller 33, and a switch controller 34. The system memory 31 is a memory that stores, for example, a program, and intermediate results during program execution. The CPU 32 is a central processing unit that reads a program from the system memory 31 and executes it. The USB controller 33 is a controller that controls peripheral devices coupled to the USB connectors 24. The switch controller 34 is a controller that, for example, detects and resets a state of the Key image transmission switch 27.

The internal storage device 22 is a non-volatile storage device, for example, a flash memory. The internal storage device 22 stores, for example, a Key image 2a, a start-up identification image 2b, and a Key image output program 2d. The Key image output program 2d is a program that outputs a Key image to the KVM switch 1. The Key image output program 2d is read into the system memory 31 and executed by the CPU 32.

The hard disk device 23 is a storage device in which a magnetic disk is provided as a storage medium, and stores an operating system (OS) and an application. The hard disk device 23 may store, for example, the images and the program stored by the internal storage device 22, and thus the internal storage device 22 may be omitted.

Each USB connector 24 is a connector that connects to a USB device with a USB cable. The graphics controller 25 is a controller that controls a graphic image displayed on the display 3. The CRT connector 26 is a connector that connects to the display 3 with a display cable. A display cable interface is, for example, an analog RGB (red-green-blue) interface, a digital visual interface (DVI), or a high-definition multimedia interface (HDMI) (registered trademark).

The system memory 31, the CPU 32, the USB controller 33, the switch controller 34, the internal storage device 22, the hard disk device 23, and the graphics controller 25 are coupled with a bus 28. The USB connector #3 is coupled to the KVM switch 1 with a USB cable, and the CRT connector 26 is coupled to the KVM switch 1 with a display cable.

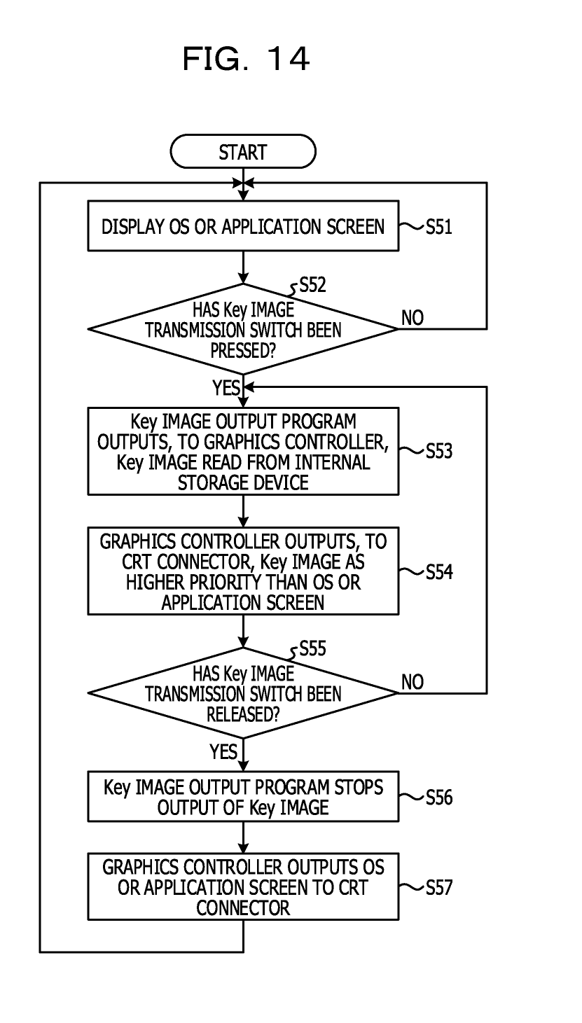

Next, a flow of a process performed by a server 2 when the Key image transmission switch 27 is pressed will be described. FIG. 14 is a flowchart illustrating a flow of the process performed by the server 2 when the Key image transmission switch 27 is pressed.

As illustrated in FIG. 14, the server 2 displays an OS or application screen in accordance with an execution state of a program (S51). Then, the server 2 determines whether or not the Key image transmission switch 27 has been pressed (S52), and when the Key image transmission switch 27 has not been pressed, the server 2 returns to S51.

On the other hand, when the Key image transmission switch 27 has been pressed, the Key image output program 2d outputs, to the graphics controller 25, the Key image 2a read from the internal storage device 22 (S53). Then, the graphics controller 25 outputs, to the CRT connector 26, the Key image 2a as a higher priority than the OS or application screen (S54).

Subsequently, the server 2 determines whether or not the Key image transmission switch 27 has been released (S55), and when the Key image transmission switch 27 has not been released, the server 2 returns to S53. On the other hand, when the Key image transmission switch 27 has been released, the Key image output program 2d stops output of the Key image 2a (S56), and the graphics controller 25 outputs the OS or application screen to the CRT connector 26 (S57).

In this way, the Key image output program 2d controls output of the Key image 2a in accordance with a state of the Key image transmission switch 27, thereby enabling the KVM switch 1 to switch between the servers 2 to be coupled to the display 3, the keyboard 4, and the mouse 5.

As described above, in the embodiment, each server 2 stores a different Key image 2a and also a common start-up identification image 2b. Each server 2 transmits a composite image 2c obtained by combining the Key image 2a and the start-up identification image 2b to the KVM switch 1 upon start-up. In addition, each server 2 transmits the Key image 2a to the KVM switch 1 when the Key image transmission switch 27 is pressed.

Each image detection unit 12 of the KVM switch 1 determines whether or not a Key image 2a and a start-up identification image 2b are contained in an image transmitted from a server 2. When the Key image 2a is contained, the Key image 2a is output to the correspondence table control unit 15. When the start-up identification image 2b is contained, the image detection unit 12 sets a start-up identification signal to ON. On the other hand, when the start-up identification image 2b is not contained, the image detection unit 12 sets a start-up identification signal to OFF. The correspondence table 71 associates a switch number with the Key image 2a, and with a connector number, and stores them. When the received image has been registered in the correspondence table 71, when a corresponding connector number coincides with the number of a connector pair 11 having received the image, and when the start-up identification signal is OFF, the correspondence table control unit 15 outputs the connector number to the connection switching control unit 16. Then, the connection switching control unit 16 switches between the servers 2 to be coupled to the display 3, the keyboard 4, and the mouse 5 in accordance with a switching signal.

Thus, the operator of the computer system 10 may switch to a server 2 desired to be coupled to the display 3, the keyboard 4, and the mouse 5 from among a plurality of servers 2 with precision and ease.

In the embodiment, when a server-switching switch 13 is pressed, the correspondence table control unit 15 outputs, to the connection switching control unit 16, a connector number associated with a switch number of the server-switching switch 13 in the correspondence table 71. Thus, the operator of the computer system 10 may switch between the servers 2 to be coupled to the display 3, the keyboard 4, and the mouse 5 from the KVM switch 1 as well.

In the embodiment, when a received image has not been registered in the correspondence table 71, the correspondence table control unit 15 associates the received image with a connector number of a connector pair 11 having received the image, and registers, as a Key image 2a, the received image in the correspondence table 71. Thus, each server 2 transmits a Key image 2a to the KVM switch 1, thereby enabling the Key image 2a to be registered in the KVM switch 1.

In the embodiment, when a received image has been registered in the correspondence table 71, and when a corresponding connector number does not coincide with the number of a connector pair 11 having received the image, the correspondence table control unit 15 erases, from the correspondence table 71, the number of the connector pair 11 having received the image. The correspondence table control unit 15 changes the connector number corresponding to the received image to the number of the connector pair 11 having received the image. Thus, even if connections between the KVM switch 1 and the servers 2 are unexpectedly changed due to maintenance or the like, the KVM switch 1 may maintain relationships between the server-switching switches 13 and the servers 2. For example, in some cases, immediately after installation, labels or the like are put near the server-switching switches 13 to indicate correspondences between the server-switching switches 13 and the names of the servers 2 coupled to them. In such a case, the display 3, the keyboard 4, and the mouse 5 may be correctly coupled to a server 2 to be operated by using a server-switching switch 13 without changing the labels.

In the embodiment, when a start-up identification signal is ON, the correspondence table control unit 15 does not update the correspondence table 71 and also does not output a connector number to the connection switching control unit 16. Thus, after the correspondence table 71 is initialized with a Key image 2a, when the computer system 10 is started up, the KVM switch 1 may be kept from performing an unneeded operation.

In the embodiment, the case where a Key image 2a and a start-up identification image 2b are used has been described. However, the embodiment is not limited to this, and may also be applied to, for example, the case where data, such as unique text of an individual server 2 and a certain pattern of text, is used.

In the embodiment, the case where the display 3, the keyboard 4, and the mouse 5 are coupled to the KVM switch 1 has been described. However, the embodiment is not limited to this, and may also be applied to the case where another peripheral device, such as a video recorder, is coupled to a similar switch.

In the embodiment, the case where the servers 2 are switched with the KVM switch 1 has been described. However, the embodiment is not limited to this, and may also be applied to the case where other computers are switched with KVM switch 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer system comprising:
a peripheral device including at least one of an input device and an output device;
a plurality of computers; and
a switching device that includes a plurality of connectors and a memory, the plurality of connectors including a connector group to which the plurality of computers are coupled and an input-output connector to which the peripheral device is coupled, the switching device coupling one connector of the connector group and the input-output connector,
wherein the switching device is configured to:
receive identification data for identifying a computer; and
couple the input-output connector and a first connector of the connector group, the first connector being represented by a first connector identifier having been associated with the received identification data and stored in the memory, when the received identification data has been stored in the memory.

2. The computer system according to claim 1,
wherein the switching device is configured to associate the received identification data with a second connector identifier representing a second connector of the connector group, the second connector having received the received identification data, and store the received identification data and the second connector identifier in the memory, when the received identification data has not been stored in the memory.

3. The computer system according to claim 1,
wherein the identification data is an image pattern different between types of the computers.

4. The computer system according to claim 1,
wherein the switching device further includes a plurality of switches associated with respective connectors of the connector group,
wherein the memory is configured to associate a switch identifier for identifying a switch with the identification data, and with a connector identifier for identifying each connector of the connector group, and store the switch identifier, the identification data and the connector identifier, and
wherein the switching device is further configured to specify a third connector identifier corresponding to a switch identifier for identifying the operated switch by referring to the memory, when at least one of the plurality of switches is operated.

5. The computer system according to claim 4, wherein the switching device is configured to:
determine whether a connector identifier associated with the received identification data in the memory corresponds to a connector having received the received identification data when it is determined that the received identification data has been stored in the memory; and
update information of the connector identifier stored in the memory in accordance with an identifier of the connector having received the received identification data when it is determined that the connector identifier associated with the received identification data does not correspond to the connector having received the received identification data.

6. The computer system according to claim 4,
wherein the switching device is configured to associate the received identification data with an identifier of a connector having received the received identification data, and store the received identification data and the identifier in the memory, when it is determined that the received identification data has not been stored in the memory.

7. The computer system according to claim 1, wherein the switching device is configured to:
determine whether the received identification data includes start-up identification data representing common data used when the plurality of computers are started up,
determine whether identification data coinciding with data obtained by removing the start-up identification data from the received identification data has been stored in the memory when it is determined that the received identification data includes the start-up identification data; and
control so that a coupling between the input-output connector and the first connector is not made when it is determined that the identification data coinciding with the data obtained by removing the start-up identification data from the received identification data has been stored in the memory.

8. The computer system according to claim 6,
wherein the plurality of computers include a computer having a switch,
wherein each of the plurality of computers is configured to transmit composite data obtained by combining the identification data corresponding to the computer and the start-up identification data to the switching device, when the computer is started up, and
wherein the computer having the switch is configured to transmit identification data corresponding to the computer to the switching device when the switch is pressed.

9. A switching device comprising:
a connector group to which a plurality of computers are coupled;
an input-output connector to which a peripheral device including at least one of an input device and an output device is coupled;
a memory; and
a processor coupled to the memory and configured to:
receive identification data for identifying a computer; and
couple the input-output connector and a first connector of the connector group, the first connector being represented by a first connector identifier having been associated with the received identification data and stored in the memory, when the received identification data has been stored in the memory.

10. A switching method executed by a switching device that includes a plurality of connectors and a memory, the plurality of connectors including a connector group to which a plurality of computers are coupled, and an input-output connector to which a peripheral device including at least one of an input device and an output device is coupled, and that couples one connector of the connector group and the input-output connector, the switching method comprising:
receiving identification data for identifying a computer; and,
coupling the input-output connector and a first connector of the connector group, the first connector being represented by a first connector identifier having been associated with the received identification data and stored in the memory, when the received identification data has been stored in the memory.

11. The switching method according to claim 10, further comprising:
associating the received identification data with a second connector identifier representing a second connector of the connector group, the second connector having received the received identification data; and
storing the received identification data and the second connector identifier in the memory, when the received identification data has not been stored in the memory.

12. The switching method according to claim 10,
wherein the identification data is an image pattern different between types of the computers.

13. The switching method according to claim 10,
wherein the switching device further includes a plurality of switches associated with respective connectors of the connector group,
wherein the memory is configured to associate a switch identifier for identifying a switch with the identification data, and with a connector identifier for identifying each connector of the connector group, and store the switch identifier, the identification data and the connector identifier, and
wherein the switching method further comprising specifying a third connector identifier corresponding to a switch identifier for identifying the operated switch by referring to the memory, when at least one of the plurality of switches is operated.

14. The switching method according to claim 10, further comprising:
determining whether the received identification data includes start-up identification data representing common data used when the plurality of computers are started up,
determine whether identification data coinciding with data obtained by removing the start-up identification data from the received identification data has been stored in the memory when it is determined that the received identification data includes the start-up identification data; and
control so that a coupling between the input-output connector and the first connector is not made when it is determined that the identification data coinciding with the data obtained by removing the start-up identification data from the received identification data has been stored in the memory.
